(19) United States
(12) Patent Application Publication
(10) Pub. No.: US 2025/0021072 A1
(43) Pub. Date: Jan. 16, 2025

(54) COMPUTER ENABLED SYSTEM FOR CALCULATION AND PROVISION OF CODING FOR OPERATION OF CNC MACHINES

(71) Applicant: John Gardner, Laguna Beach, CA (US)

(72) Inventor: John Gardner, Laguna Beach, CA (US)

(21) Appl. No.: 18/771,948

(22) Filed: Jul. 12, 2024

Related U.S. Application Data
(60) Provisional application No. 63/526,424, filed on Jul. 12, 2023.

(51) Int. Cl. G05B 19/18

(52) U.S. Cl. CPC G05B 19/18; G05B 2219/33099; G05B 2219/37336

(57) ABSTRACT

A system for generating control code for controlling the movements of a CNC machine to form a keyway in a workpiece is provided. The generated control code is calculated using stored dimensions of a tool holder having a unique identifier along with a known position on the tool holder of a cutting tool along with input choices by a user for a length and depth of the keyway on the chosen workpiece. Once generated, the control code is communicated electronically to the user for input to the control software for their CNC machine.

### FIELD OF THE INVENTION

This application claims priority to U.S. Provisional Patent application Ser. No. 63/526,424 filed on Jul. 12, 2023.

The present device relates to CNC machines and their operation. More particularly, it relates to a computer and software-enabled system for calculating and providing downloadable lines of code generated from input parameters provided by the user. The downloaded lines of code are employable to operate a CNC machine producing components and may be communicated using a bar code.

### BACKGROUND OF THE INVENTION

In modern production of parts and components and the like, a CNC machine is widely employed. CNC is an acronym for “computer numerical control” which essentially is the automated control of machining tools (such as drills, lathes, mills, grinders, routers and 3D printers) through the employment of a computer having software running in memory thereof operating to control the movements of the machine and tools engaged therewith.

In modern CNC machining systems, the design of a mechanical part or component and the required manufacturing programming to generate that part, are highly automated. The desired mechanical dimensions of the designed part or component are defined using CAD software. Once so designed, the required dimensions of the finished part and the machine steps to generate it are then translated into manufacturing directives by computer-aided manufacturing (CAM) software or in some cases the CAD design software. The resulting directives are transformed (by “post processor” software) into the specific commands or control code programmed instructions for the tool and machine platform movements necessary for a particular machine to produce the part or component. These software commands or coded programmed instructions are then operatively communicated into the appropriate CNC machine.

In operation, the CNC machine employs tooling and driven platform movements to process a piece of raw material or a workpiece, such as metal or plastic, which is operatively engaged with the CNC machine, into the desired final dimensions of the part or component. This computer control of such machining tools operates to form the component to the desired specifications through movements of tools and/or a platform and the like. These movements are controlled by following the coded programmed instructions.

Where in the past a human operator was required to operate the machining tool through many tool passes against and across the raw material, a CNC controlled machine tool will operate without a manual operator directly controlling the machining operation. Because each tool movement is software and computer-controlled, the resulting machined part or component is generally much more accurately produced.

In operation, a conventional CNC machine employs a motorized maneuverable tool engaged to a mount and often a motorized maneuverable platform. The cutting tool itself is held in a fixed position to a tool holder usually with compression screws and the like. Both the tool connected to the tool holder with is mounted to a platform, and the platform movement, during the machining process, are controlled by the control code programmed instructions which, as noted, are generated to control movements. Such movement instructions or lines of control code are electronically communicated to the CNC machine in the form of a sequential program including sequentially implemented machine control instructions in conventional coding language.

Cutting keyways with inserted broaching tools is a modern broaching method, using a tool holder with replaceable cutting inserts. These keyway cutting tools can be used on CNC machines and a variety of other machines for slotting and shaping. This offers greater flexibility and reduced tooling costs compared to traditional broaching. Keyway cutting using this method on a CNC lathe or machining center eliminates the need to re-clamp the tool on a separate machine in order to broach the keyway.

In a static method for cutting a keyway, the workpiece or part being machined is clamped in a static position. Then the keyway is cut by a cutting tool mounted on a tool holder using a series of translating successive passes of the tool against the workpiece. The tool removes an equal amount of material with each pass until the required size of the keyway is achieved.

In tool translating mode for forming a keyway upon a workpiece, the tool is engaged in the tool holder which is placed in a fixed connection to a power driven mount. The power driven mount, such as a driven broaching unit, generates the translating movement of the tool holder and the tool engaged at the distal end thereof opposite the mounting end.

Conventionally, however, the machinist must mount the cutting tool into a fixed mount which may move or may hold the tool as the workpiece moves, or it will hold the tool as the mount moves. The machinist must take multiple measurements to ascertain the position of the cutting edge of the cutting tool, as mounted, and then calculate code lines to move the tool mount and tool and cutting edge to form a desired keyway. This is tedious at best and prone to error.

In both modes, the system herein employs a tool holder from a group of tool holders having identifiers thereon with a known fixed total distance from a rear end of the mount to the cutting tool point of contact. Each of the tool holders has such an identifier which correlates to a stored configuration thereof which includes the total distance or length of the tool holder as well as a cutting length thereof from the mounting end which is configured to engaged with the mill or lathe. The employment of such a tool holder, with an identifier correlating to the known total length and cutting length to the cutting tool edge, allows the user to input information as to the identifier of the tool holder and other information concerning the formation of the keyway into a workpiece or part, into the graphic interface.

Once so entered, the system, employing keyway formation software operating to take the known distances of the tool holder once the mounting end is engaged and the other input parameters from the user as to the desired keyway, will calculate the lines of code to move the tool cutting edge against the workpiece to form the desired keyway on the workpiece. The user, as noted, may employ the communicated lines of code to the CNC lathe or mill, whereupon it will be operable to form the keyway in a workpiece of part as required by the user.

While, as noted, the computer programming or coded programmed instruction to machine each keyway or component or part to be manufactured by such a CNC machine can be written by a person. However, due to the complexity and large number of lines of code required for the high number of movement operations of the CNC machine, such coded programmed control code is more often generated by graphical computer-aided design programs (CAD) or computer-aided manufacturing software (CAM). Such instructions for CNC control, and, more modernly 3D, printer controls are generated in a conventional control code language called G-code. There can be hundreds of lines of such control code or G-code in the coded programmed instructions for a single part.

However, the advantages of electronic design and production coding come at significant cost in terms of both capital expenditure and job setup time. Further, for some prototyping and small batch jobs, where there is no CAD programming, the employment of a CNC machine is not a good option since there are no CAD designs for generation of G-code.

The forgoing background concerning the conventional manner for part design and generation coded programmed instructions for manufacture, and the limitations related therewith are intended to be illustrative and not exclusive, and they do not imply any limitations on the system described and claimed herein. Various other limitations of the related art electronic design and CNC machine control are known or will become apparent to those skilled in the art upon a reading and understanding of the specification below and the accompanying drawings.

### SUMMARY OF THE INVENTION

The G-code generation system herein provides a computer interface allowing users desiring coded programmed instructions for a CNC machine employed for cutting or broaching to produce a desired component or part to generate the appropriate lines of control code also known as G-code, therefor. By control code herein is meant lines of computer code employable by the identified CNC machine, to cause translation of a workpiece against a cutting tool edge to thereby form a keyway in a broaching process.

The system. as noted, is currently especially well adapted for this broaching process to form keyways into workpieces. It allows users without or lacking CAD designs for a desired part or component to easily employ the provided graphic interface to input an identifier of a broaching tool holder provided by the system provider from a group thereof along with additional information and to then receive machine employable instructions for manufacture of the part. With the information regarding the identified tool holder, along with a keyway or cutting tool width desired or mounted thereon and along with input of some of the finished keyway or part or component measurements, the system will quickly provide a CAD manufacturing solution which is loadable to the software running cutting movements during CNC processing.

Key to operation of the system herein, the interface provides the user with choices to input an identifier of an individual tool holder from a group of tool holders provided by the system provider. Each such tool holder has a unique identifier which, as noted, is stored in electronic memory along with known fixed dimensions of the identified tool holder.

The system provider makes available to users a group of individual tool holders. Each such tool holder has a respective unique tool holder identifier. All of the tool holders are configured with a mounting end to hold the tool holder to a moving or static mounting position depending on the manner in which the keyway is formed.

So mounted at the mount on the mounting end, the tool holder will securely hold a cutting edge of a broach cutting tool in a mounting slot with the cutting end of the cutting tool in a known position on the identified tool holder. The combined tool holder and cutting tool is then employed to remove metal to form a keyway into the workpiece or part. The system herein is particularly employable in such a broaching process where a tool holder in a fixed mount is moved sideways under power to remove small layers of material to form a recess on the part being manufactured or where the workpiece moves relatives to a fixed tool holder.

Using software operating to the task of employing the user-inputted tool holder identifier and the type or identification of the CNC machine being employed, software running in electronic memory of the computer processor of the system provider will operate to the task of generating and/or matching such inputted information to a correlated database of CAD control code, and then based on that comparison, it will designate lines of control code or G-code which will operate the particular CNC machine to produce the movements thereof to form the desired keyway or recess in the desired part or component using a broaching process.

The system employing software operating to the task of generating the required lines of control code will then either electronically transmit such to the user and/or depict the calculated or retrieved G-code lines on the display screen of the user. When transmitted for display on the video display of the user, the control code may be copied and pasted by the user into the local computer program configured for controlling the CNC movements of the identified machine. Where the control code or G-code is electronically communicated as an electronic file, it will be in a format that is loadable to the software controlling the movements of the CNC machine.

The system herein, in operation, will provide the appropriate display screen interfaces to the user over a computer network, such as the internet. In all modes of the system and steps herein noted, the system provider will employ network accessible servers or computers having accessible electronic memory for storage and retrieval of electronic database information relating to standard G-code and other norms and related data needed correlating to the stated part dimensions and/or steps or requirement of the operation noted to be performed by the software. Software, running in electronic memory, will operate to allow user input of data or information required for the calculation of control code or the like and will then function to provide each individual assessment needed to determine the appropriate lines of control code or G-code to operate the identified CNC machine, using an identified tool holder, to produce the part or component having the identified dimensions input to the graphic interface of the service provider.

Employing the system herein with the tool mounts having identifiers and the graphic interface, the user can reduce the programming time required to produce the many lines of control code which control movements of the CNC or other machine during the CNC process, from hours to minutes. The system using a graphic display communicated to the computer system of the user allows for easy menu-driven inputs by the user for part formation, for example the operation of a broaching cycle for a CNC Lathe or a CNC Mill.

To determine the proper lines of control code for any part or component to be produced by the identified CNC machine, there are provided in the graphic interface seven to nine inputs of data concerning the part being machined. In addition to input areas for designation of the identifier of the specific tool holder and the type of CNC machine, windows or areas for text input of various measurements of the desired finished part are provided to the user as well.

Once the data has been input to the appropriate windows or areas on the communicated graphic interface along with the tool holder identifier and type of CNC machine, an actuation button or hitting enter on a keyboard will start the software generation process. Actuating a graphic button or a keyboard key will cause the system to take the user data inputs and to employ software operating to the task of generating new code for machine movement or identifying stored lines of machine movement control code which have matching data inputs and tool holder identifiers. Thereafter, the software will operate to generate the control code to manufacture the keyway into the identified part or workpiece.

The system, through communication with users over a network, such as the internet, can communicate up to 2000 or more lines of CNC control code or G-code to a user. The lines of control code can be communicated electronically, such as by email, or can be presented on a graphic display of the user as text which may be copied. The user can then paste the copied communicated CNC control code into the computer program or system which operates and controls their specific CNC machine.

For example and in no way limiting, control code lines to control a CNC broaching machine for a broaching operation of a part requires multiple passes by one or more cutting edges of the cutting tool mounted in the identified tool holder, remove small amounts of material, usually between 0.0006″-0.0020″, per pass. The cutting edge of the cutting tool on one end of the identified tool holder for forming a slot having a radial depth of 0.400″ and a depth of cut of 0.001″ per pass, for example, would require 400 individual cutting edge or tool passes to form the keyway. When creating a long hand lathe or mill program, each pass requires a minimum of four lines of CNC control code or G-code. The general layout for each complete pass is as follows:
1. Position/Reposition on X, Y, Z
2. Feed in on Z axis
3. Retract out on X axis
4. Retract out on Z axis

The example above, which has 400 passes, would require 1600 lines of control code or G-code. Sometimes the length of the computer program can be condensed by using a sub-program with incremental moves and multiple calls. This generally will work unless there is limited clearance behind the cutting tool.

For example, where a 0.750 bore is required and the CNC machine is using a tool holder with a tool identifier of T6MML from CNC Broach Tools of Laguna Beach, California, which fits into 0.745 min bore, an incremental computer control program with a 0.150 retract for every pass will crash after the first pass when it retracts out of the cut on X. In such a case, the user will need to write a long-hand CNC control program and set the retract point for each pass to an absolute position of 0.745 instead of using an incremental position.

Using the system herein, the user first selects the type of program CNC control code they wish to export from a drop down or other menu including long format or sub program format. Based on this choice, the system provider will communicate a displayed input graphic interface to the computer of the user which provides entry windows for text data during the process. These inputs include entry of the specific tool holder identifier of the tool holder being used, the bore diameter of the part into which the keyway is to be formed, the desired keyway width to be formed by the cutting edge of the cutting tool, the desired radial depth, a Z axis, start and end points, a depth of cut, and speed PM. Where a milling machine has been chosen from the provided graphic interface menu, the user will also enter a feed axis and feed direction.

Based on the above inputs by the user to the communicated graphic interface displayed on the user computer display, which are communicated to the computer or server of the service provider, using the known dimensions of the identified tool holder and known position of the cutting edge of the cutting tool in that identified tool holder, and other user input information, the number of required passes to form the desired part will be calculated along with the translating action by the CNC and tool on each respective pass. By pass herein is meant a contact of a cutting edge of a cutting tool with the material being machined to remove a layer or portion thereof in a sequential process from a beginning pass to a final pass of the cutting edge of the cutting tool mounted in the identified tool holder, against the material being cut or processed to the part or component.

The server or computer of the service provider, using the identified tool holder and desired width and length of the slot or key way, upon calculation of the number of passes required by the cutting tool in the identified holder, will then calculate and write the required lines of control code to control movements of the CNC machine and tool holder and cutting tool and/or platform, for each required pass. While currently the control code so generated using the tool holder identifier and other information works particularly well for a broaching operation, it is envisioned the system could be used for generating control code for other operations.

Once the control code has been calculated by the system, the user will be given the option to copy a display of the required lines of control code for pasting into their local software, or they may receive an electronic communication or file containing the lines of control code so that control code may be operatively communicated into the local software which controls the movements of the machining provided by the CNC machine of the user. As can be discerned, this provision of hundreds of lines of control code to control hundreds of individual CNC actions alleviates the need for the user to write such control code by hand.

As noted, some lines of control code may be calculated by software operating to that task and running on the server or computer of the service provider. Other lines of control code may be held in a database of such control code which is associated with the movements required by the identified tool holder with the cutting tool and/or platform of a CNC machine to produce the cut or required contact against the material being processed into a part or component. Where such is recognized from the user inputs for the desired keyway using the identified tool holder, it may be retrieved from the stored control code in electronic memory.

In either fashion, software operating to the task on the server or computer of the system provider will discern the lines of control code required for the user based on the inputs into the communicated graphic interface and may either employ software operating to the task of writing the individual lines of control code or matching the input parameters from the user to lines of code associated previously with the required movements of the tool or platform and CNC machine to make each respective cut or pass of the tool.

As to electronic memory or computer readable media for the system herein for software calculating lines of control code or software comparing user inputs and retrieving lines of control code from a database, any combination of one or more computer-usable or computer-readable media, be it transitory or non transitory, may be employed for operation of control code or G-code generation or the identification and provision of control code or G-code in the system herein. Such, for example and in no way limiting, can include computer-readable media which may include one or more of a portable computer diskette, a hard disk, a random access memory device, a read-only memory device, an erasable programmable read-only memory (EPROM or Flash memory) device, a portable compact disc read-only memory device, an optical storage device, and other electronic memory magnetic storage devices. Software or computer program code for carrying out the individual and sequential operations to either generate or identify stored code and thereafter provide the required G-code of the present invention may be written in any combination of one or more programming languages.

The steps or method of operation and/or execution of the various modes and tasks of the control code or G-code generation and provision system herein may be illustrated as blocks or steps in the drawings which may represent one or more sequences in the operation of the steps and assessments in the system herein. These operations or steps can be implemented in hardware, software operating to process input data to accomplish the task or step, or a combination thereof.

With regard to software operating to a task or steps or assessments indicated in the system herein, such represents computer-executable instructions stored upon one or more transitory or non-transitory computer-readable storage media, which, when executed by one or a plurality of processors, will operate to perform the recited task, assessment, operation or step. Computer-executable instructions, in general, include routines, programs, algorithms, data structures, and the like which are configured to perform particular functions or to implement particular abstract data types or steps noted.

It should be noted that the sequence in which the steps of the system herein are described or depicted for the provision of CNC machine operation coding are not intended to be construed as a limitation. It should be understood that any number of the described or designated steps can be combined in any order and/or in parallel to implement the described and depicted processes. In some modes of the system herein, one or more steps can be rearranged or omitted entirely. Still further, the software-enabled steps in the system herein can be combined in whole or in part with each other or with other steps or methods.

With respect to the above description, before explaining at least one preferred embodiment of the herein disclosed CNC operation code provision system detail, it is to be understood that the invention is not limited in its application to the details of construction and to the arrangement of the components in the following description or illustrated in the drawings. The control code or G-code generation system for CNC operation herein based on user input as described and disclosed is capable of other embodiments and of being practiced and carried out in various equivalent ways which will become obvious to those skilled in the art upon reading this disclosure. Also, it is to be understood that the phraseology and terminology employed herein are for the purpose of description and should not be regarded as limiting.

As such, those skilled in the art subsequent to reading this disclosure will appreciate that the conception upon which this disclosure is based, may readily be utilized as a basis for the identification and generation of computer code for CNC operations and substantially equivalent structures methods and systems for carrying out the several purposes of the present disclosed device. It is important, therefore, that the claims be regarded as including such equivalent configurations, constructions and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially”, unless otherwise specifically defined, means plus or minus five percent.

It is an object of the present invention to provide a network accessible computer graphic interface for the provision of control code or G-code to operate CNC machines for part production, such as the formation of keyways.

It is a further object of this invention to provide such a system which allows users to input a tool holder identifier along with some desired finished component and keyway dimensions of a part or component processed by a CNC machine, and thereby generate customized control code or G-code to control the translation of CNC machine while using the identified tool holder.

These and other objects, features, and advantages of the present system to provide CNC movement control coding to users base on user input of a tool identifier and other noted parameters, as well as the advantages thereof over existing prior art, which will become apparent from the description to follow, are accomplished by the improvements described in this specification and hereinafter described in the following detailed description which fully discloses the code provision system, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed CNC code or G-code generating and provision system herein. It is intended that the embodiments and figures disclosed herein are to be considered illustrative of the CNC control code generating invention herein, rather than limiting in any fashion.

In the drawings:

FIG. 1 depicts a view of an exemplar of a graphic interface which is communicated to a user by the system provider which provides predefined input areas for the tool identifier, and keyway or cutting tooling used and the required movement during processing of material by a CNC machine to a finished part or component.

FIG. 2 depicts a sectional view of the calculated formed keyway or slot formed in a workpiece using the user input data to the graphic interface of the system herein to generate control code to control cutting tool positioning during a broaching process on a CNC machine.

FIG. 3 is a depiction of a conventional mill employable with the system herein.

FIG. 4 is a depiction of a conventional lathe employable with the system herein.

FIG. 5 shows a tool holder having an identifier thereon which may be input into the provided video interface to allow for customized generation of control code or G-code to control a CNC machine in which the tool holder is engaged to form the desired machine part.

FIG. 6 is a distal end view of the tool holder of FIG. 5 showing the cutting tool thereon mounted in a slot and showing in dotted line the smallest axial bore in which the tool holder with tool mounted thereon will fit.

FIG. 7 depicts a side view of the tool holder of FIG. 5 which, as noted, is especially well configured for a broaching process by a CNC lathe or mill to which the tool holder is operatively engaged and shows some of the stored measurements.

FIG. 8 is an enlarged view of the cutting end of the tool holder of FIG. 5 showing the cutting tool operatively mounted in a slot wherein the cutting length of the cutting edge is fixed and known by the system.

### DETAILED DESCRIPTION OF THE INVENTION

In this description, the directional prepositions of up, upwardly, down, downwardly, front, back, top, upper, bottom, lower, left, right, first, second, and other such terms refer to the configuration of the system herein as graphic interfaces may oriented and appear in the drawings and all such terms are used for convenience only and such are not intended to be limiting or to imply that the disclosed device has to be used or positioned in any particular orientation.

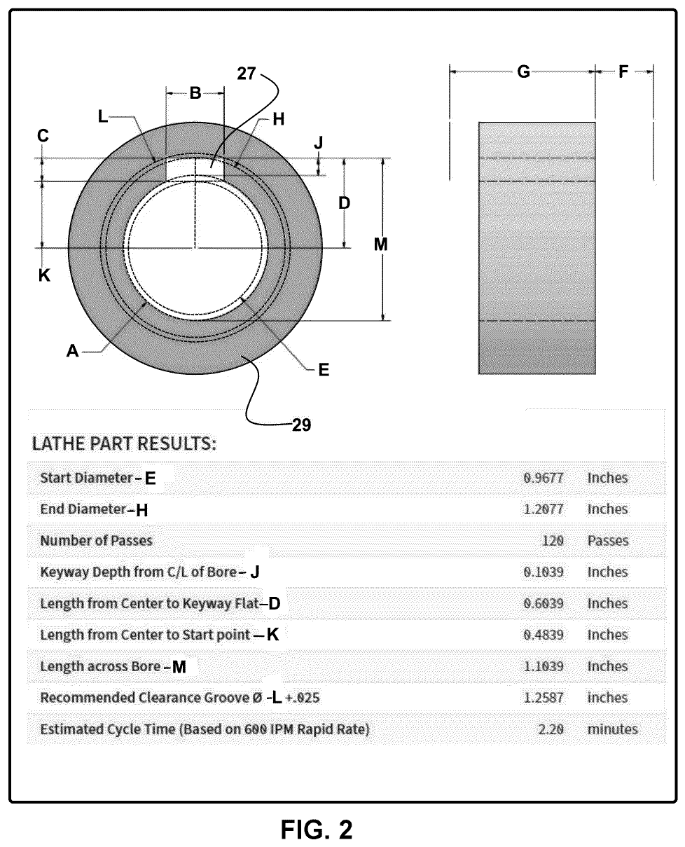

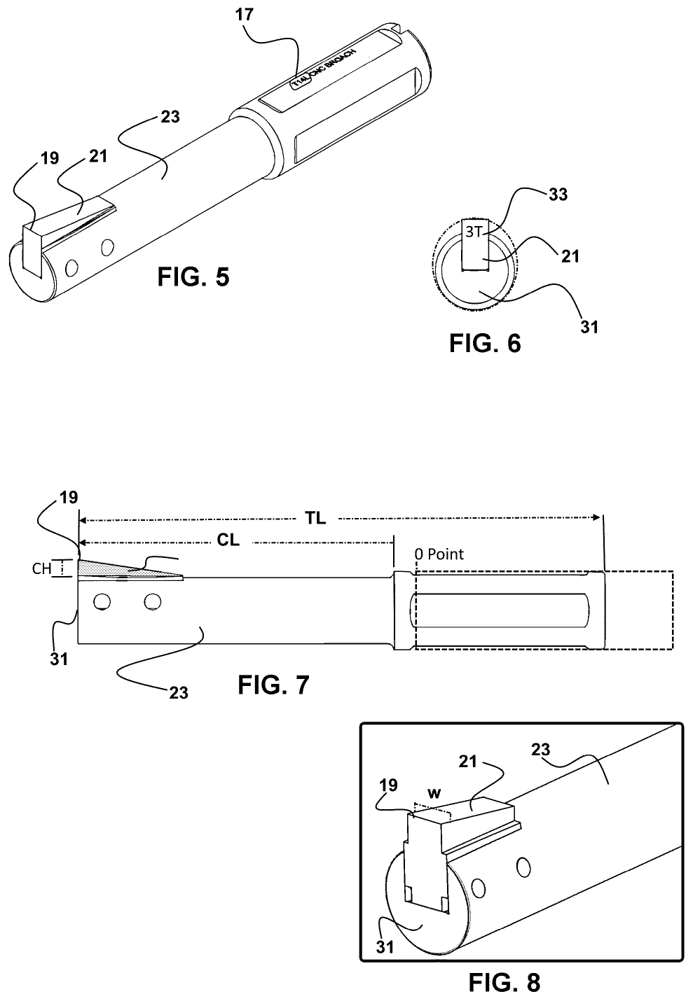

It should be noted that the system herein is especially well configured to generate control code, also known as G-code, for the operation of a CNC machine for broaching a component to form a keyway 27 (FIG. 2). However, as noted, where a tool holder 23 with an identifier 17 (FIG. 5) correlating to known positioning of the cutting tool 21, mounted thereon, can be used in other machining operations to which the system may be adapted to provide control code or G-code for such other operations.

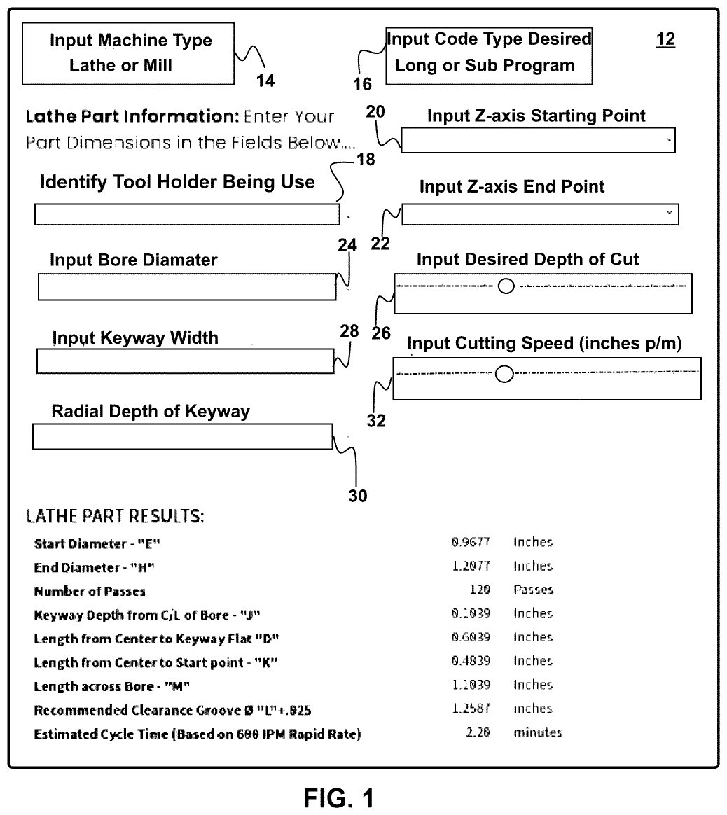

Now referring to the drawings in FIGS. 1-8 in FIG. 1, there is depicted an example of a graphic interface 12 which is generated by the system provider and communicated to the video display of a user. The graphic interface 12, as noted, includes a designation of the type of CNC machine 14 being used, currently such as between a lathe or mill. The user may input their choice of the type of CNC machine that being one of a lathe or a mill.

Another input, which may be provided in the graphic interface 12, is a user choice of the type of control code 16 they wish to be generated by the system herein and communicated back to the user. By type of control code 16 is meant the user will choose between long code lines or sub program coding which are conventionally employed to control movement of CNC machines. Control code itself is defined above. However, this definition includes other types of control code to operate an identified CNC machine where such control code is employed.

In another data input area, employed by software of the system herein to discern the required lines of control code for a user of the system, is an input of a tool holder identifier 18. This step is preferred in all modes of the system and will allow the user to identify by input, the tool holder identifier 17 (FIG. 5) correlating to a specific tool holder 23 to be employed by the user in the CNC processing session to form the part or component. The system provider can provide a group including multiple respective such tool holders 23 with specific respective identifiers 17.

As noted, the tool holders 23, such as shown in FIG. 5, have respective identifiers 17 for each in the group thereof which are correlated to database-stored known dimensions thereof. Such known dimensions include a known positioning of the cutting edge 19 of the cutting tool 21 with the cutting tool 21 operatively engaged with a tool holder 23 and with that tool holder 23 coupled to a CNC machine-driven mount or static mount, such as with a clamping shank 25 or the like, as in FIGS. 5-8. Each such tool identifier 17 correlates to an individual tool holder 23 which has such known dimensions stored in relation therewith in a database of tool holders 23. This known positioning enables the control code generating software herein to calculate the proper control code to operate the CNC machine to form a keyway 27 into the workpiece 29, based on the identifier 17 and the other workpiece and keyway information entered by the user to the graphic interface 12.

The control code generated will operate the CNC machine to form the desired keyway 27 once entered into the controller of the CNC machine and the a zero point is determined and input by the user in a conventional determination of such by machinists such as for example determining the initial contact point of the cutting edge 17 with the side surface of the workpiece 29.

The tool holder identifier 17, as noted, identifies a unique tool holder 23 from a group thereof provided by the system provider. Thus, the system provider has the exact dimensions of each tool holder 23 which may be associated with an individual tool identifier 17 of the tool holder. However, the system provider may associate other tool identifiers 17 with individual tool holders 23 of other manufacturers, once the system provider has determined the exact dimensions of such which are used in the code calculating process.

The tool identifiers input 18 of the tool holder identifier 17 may be done by inputting text, or by a drop down listing of known tool holder identifiers 17 for which the software of the system provider will operate to generate the required control code or G-code. The system provider will on continuous basis, maintain a database of system-provided tool holders having individual identifiers 17 as well as other tool holders of other manufactures and their associated identifiers which are employed with such CNC machines. Thus, the user may easily identify the tool holder 17 they are going to use for which the system has tool holder dimensions thereof.

The input 18 chosen tool holder identifier 17 from the user is employed by the software operating to the task, to determine the lines of control code required by the identified CNC machine to cut and produce the keyway 27 or a desired part or component where the system is used for other CNC cutting operations. Taken into consideration of the software operating to this task are the identified tool holder 23 dimensions and the cutting tool 21 cutting edge 19 position on the identified tool holder 23 along with the other input data on the displayed input page.

Such additional input variables, used by the software, may also include a Z-axis starting point input 20 which is provided in the graphic interface 12 for input by the user. This, as noted, is the starting point or zero point where the cutting edge 19 will contact the workpiece 29 initially. The user will thus input a Z-axis starting point which is preferably employed by the software operating to the task to determine the required lines of control code for the CNC machine such as for the distance of travel of the cutting edge 19 against the workpiece 29 to form the keyway 27 in the desired length and depth into the workpiece 29.

Also provided is a user input area of the graphic interface 12 for the user to provide a Z-axis end point 22. The user will input values for Z-axis endpoint, such as the total length of the keyway 27 into the workpiece 29. This input endpoint value is employed by the software of the system operating to generate the control code required by the CNC machine for the user to form the keyway 27 into the workpiece 29.

In an additional area for user input, where the keyway 27 is formed along an axial bore of the workpiece 29, is a designation of a bore diameter 24. The user will at this step input a bore diameter size of the passage in which the tool holder with cutting tool will be positioned and translate. This input bore diameter 24 is another value employed by the software of the system operating to the task of determining the lines of control code required by the user CNC machine.

Also input by the user and employed by the software of the system herein operating to determine and provide lines of control code are a desired depth of the cut per pass 26 of the cutting tool 21 in sliding contact with the workpiece 29. Additionally input are the keyway width (“B” on FIG. 2) desired 28, input of a radial depth 30 (“J” on FIG. 2) of the keyway 27 to be formed, and input of a desired speed in inches per minute 32 to be employed during the CNC process. Some of the values noted to be input may not be necessary for all keyway cutting control code generation.

Using the user inputted values, noted into the graphic interface 12, control code generation software operating to the task of employing the input values and information and determining the individual lines of control code required and number thereof, to make the passes of the identified tool holder 23 and cutting tool 21 on the user CNC machine, will determine the lines of control code required to operate the identified CNC machine to form the desired keyway 27.

The control code generation software operating to this task may calculate new lines of control code and/or it may compare the input information from the user, to search and find matches to stored input information with substantially identical values and the lines of control code used in such prior operations and which is employable by the user for the operation of their CNC machine. Such stored lines of control code can be held in electronic memory and correlated to the input data from the graphic interface wherein matching input data from a subsequent user would correlate to the stored control code already generated for such matching inputs.

Thereafter, control code generation software operating to the task of assembling the required lines of control code determined by the system to operate the CNC machine to move correctly along one or all of the X, Y, and Z axis, to form the desired keyway 27 or part, will give the user the choice of displaying such lines of code upon a display screen to allow for screen copying and pasting by the user, or electronically communicating a file of the determined lines of control code to the computer being employed by the user to communicate with the system.

The user, upon receipt of the generated lines of control code, will either copy and paste the communicated lines of control code to the video input of the CNC machine, or will move the file containing the control code to thereby operatively insert the lines of control code into the local CNC control software for their identified lathe or mill. The direct communication of finished lines of control code the system has determined will operate the CNC machine to form the keyway 27 in the workpiece based on the identified tool holder and other input information will as noted, alleviate the requirement for the user to hand write such control code or G-code. As can be discerned, such will greatly enhance the operations of their respective CNC machine.

As noted in FIG. 2 is shown a sectional view of a calculated formed keyway 27 in a workpiece 29 using the user input data to the graphic interface 12 of the system herein to generate control code to control cutting tool positioning during a broaching process on a CNC machine. Also shown are the calculated values the code generation software determined and showing a workpiece configuration recommended.

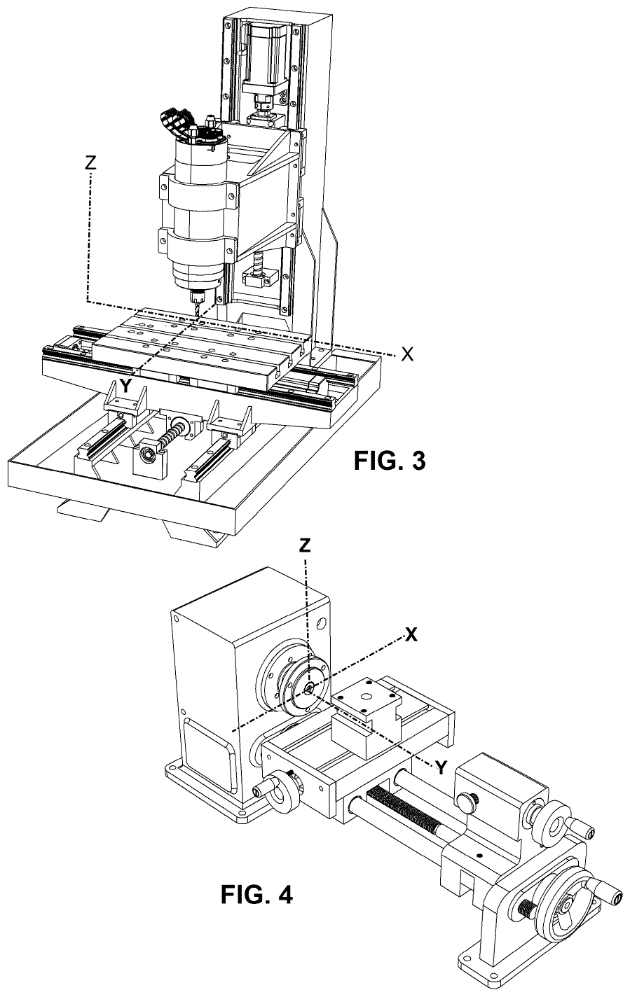

Shown in FIG. 3 is a depiction of a conventional mill employable with the system herein. Shown in FIG. 4 is a conventional lathe. Conventional mounts to hold either the workpiece 29 static where the tool holder 23 moves under power, or to hold the tool holder 23 static where the workpiece 29 moves under power, are well known and would be employed with the tool holder 23 and system herein.

As also noted above, FIG. 5-8 show various views of the tool holder 23 with an identifier 17 which is configured to hold a cutting tool 21 having a cutting edge 19. As shown and used in control code generation software the tool holder 23 has a total length TL, a length of possible translation and cut C, and a cutting height CH and cutting width W of the cutting tool 21. As shown, the tool holder 23 provided by the system provider locates the cutting tool 21 within a slot with set screws which serves to always position the cutting edge 19 substantially flush with a front surface 31 of the cutting tool 23.

As an option in the system herein, the cutting tool 21, as shown in FIG. 6, may also have a cutting tool identifier 33. This identifier would be associated with the exact measurements of the width W of the cutting edge 19 and the cutting height CH of the cutting edge 19 which can vary. The system may then suggest to the user the employment of a particular cutting tool 21 with the proper cutting height CH and width W, to form the keyway 27 desired by the user.

As noted, any of the different configurations of the graphic interface and input parameters thereof shown and described in the system herein can be employed with any other configuration shown or described herein as part of the system to discern and provide control code lines to control a CNC machine of a user.

Additionally, while the disclosed system has been described herein with reference to particular embodiments thereof and components and software enabled actions thereof, a latitude of equivalent modifications, various changes and substitutions are intended in the foregoing disclosures and it will be appreciated that in some instance some features, or configurations, or operations of the system could be employed without a corresponding use of other features without departing from the scope of the invention as set forth in the following claims. All such changes, alternations and modifications as would occur to those skilled in the art subsequent to reviewing this specification, are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract included herein is neither intended to define the invention of the application, which is measured by the claims, nor is it intended to be limiting, as to the scope of the invention in any way.

What is claimed is:

1. A system for generating control code to control movements of a CNC machine to form a keyway in a workpiece where said CNC machine is operatively engaged with a respective tool holder from a group of tool holders each having a respective tool holder identifier correlating to known dimensions of said respective tool holder and having a known positioning of the cutting tool mounted thereon, comprising:
a processor, and
a non-transitory, computer readable medium communicably coupled to the processor and storing instructions that, when executed by the processor, cause the processor to perform operations comprising:
communicating a graphic interface to a video display of a user, said graphic interface having an input area for said user to identify a respective tool holder identifier of a chosen tool holder to be employed for cutting a keyway;
said graphic interface having an input area for said user to identify a type of CNC machine to which said chosen tool holder is engaged;
said graphic interface having an input area for input by said user of a Z-axis starting point for said keyway;
said graphic interface having an input area for input by said user of a Z-axis end point for said keyway;
said graphic interface having an input area for input of a desired depth of said keyway;
said graphic interface having an input area for input of a desired width of said keyway;
said graphic interface having an input area of input by said user of a bore diameter of a passage in a workpiece in which said keyway is to be formed;
control code generation software operating to the task of determining the known dimensions of said tool holder having said input tool holder identifier and said known positioning of a cutting tool thereon;
said control code generation software based on said determined known dimensions of said tool holder having said input cutting tool identifier and said determined positioning of said cutting tool upon said cutting tool having said cutting tool identifier, operating to the task of generating lines of control code to control movements of said type CNC machine input by said user, to cause said CNC machine to form said keyway on said work piece where said keyway has a length thereof running between said z-axis starting point input and said user and said z-axis end point, and said keyway having said desired depth of said keyway input by said user and said keyway having said desired width of said keyway input by said user; and
communicating said lines of control code generated by said control code generation software to said user for input to said lines of control code to said CNC machine.

2. The system for generating control code to control movements of a CNC machine of claim 1 additionally comprising the steps of:
including in said graphic interface an input area for said user to identify a chosen format of control code desired; and
employing said control code generation software to generate said lines of control code for communication to said user in said chosen format.

3. The system for generating control code to control movements of a CNC machine of claim 1 additionally comprising the steps of:
including in said graphic interface an input area for said user to identify a chosen cutting speed for forming said keyway; and
employing said control code generation software to generate said lines of control code for communication to said user to cause said CNC machine to operate at said cutting speed chosen by said user.

4. The system for generating control code to control movements of a CNC machine of claim 2 additionally comprising the steps of:
including in said graphic interface an input area for said user to identify a chosen cutting speed for forming said keyway; and
employing said control code generation software to generate said lines of control code for communication to said user to cause said CNC machine to operate at said cutting speed chosen by said user.
